(19) United States
(12) Patent Application Publication
(10) Pub. No.: US 2003/0144970 A1
(43) Pub. Date: Jul. 31, 2003

(54) Project management database and method of managing project related information

(76) Inventor: Patrick J. Coyne, Washington, DC (US)

Correspondence Address: COLLIER SHANNON SCOTT, PLLC, 3050 K STREET, NW, SUITE 400, WASHINGTON, DC, 20007, US

(21) Appl. No.: 10/315,196

(22) Filed: Dec. 10, 2002

Related U.S. Application Data
(60) Provisional application No. 60/337,158, filed on Dec. 10, 2001.

(51) Int. Cl. G06G 7/00

(52) U.S. Cl. 705/400

(57) ABSTRACT

A database, and method of using the same, are provided for managing professional services projects. Professional services practices typically employ distributed proprietary applications which complicate the ready transfer of data between and among applications. The database of the present invention is preferably built on an ODBC-compliant platform, such as Lotus Notes and operates in conjunction with an SQL database. Data is secured from the distributed proprietary databases by the SQL database server and supplied to an ODBC-compliant database in Lotus Notes. The data is stored in portable format in the Lotus Notes database, providing an easily accessible data warehouse for the professional services practice.

### PRIOR APPLICATIONS

This application claims priority on U.S. Provisional Application No. 60/337,158, filed Dec. 10, 2001, and U.S. Utility application Ser. No. ______, filed Dec. 10, 2002, for a Method and System for the Management of Professional Services Project Information, each of which are incorporated herein by reference, as if fully set forth herein.

### FIELD OF THE INVENTION

The present invention relates to a database for managing projects and a method of using that database to manage project related information. The present invention has particular utility in managing data used in a professional services practice, specifically, a law practice. The present invention preferably facilitates the transfer, compilation, aggregation, integration, and/or distribution of data from distributed proprietary applications that are used in the practice in a manner and makes the information more readily available to a user. The data may be in: one or more software applications; proprietary, portable, or application-independent format; structured, semi-structured, or unstructured format; centralized or distributed database(s); and/or compatible or incompatible formats.

Data typically must be transferred, cleaned, converted, and/or coded from a native format into the recipient's format, before it can be used by the recipient. Proprietary formats result in incompatibilities between data bases and applications. Frequently, the incompatibility is so severe that the data may need to be re-keyed or otherwise reentered. Data may be coded in one format, converted to another format so that it can be transferred or exchanged, and converted back into the first or other proprietary formats for subsequent processing. Third parties may not have access to the formats used at various stages of processing, requiring further conversion.

### BACKGROUND OF THE INVENTION

Professional services practices rely on information from disparate sources. A medical practice, for example, may maintain: patient identifying and contact information; medical history records; financial and accounting software to generate bills, process insurance and third party payment claims, and perform accounts receivable, accounts payable, general ledger, and payroll functions; and various other systems. In a hospital or clinical setting, separate software systems typically manage radiology, pharmacy, laboratory, and nursing functions. Private physicians typically use separate software systems for scheduling; accounting; word processing; and retrieving laboratory records. In addition, various expert systems have been developed to assist in diagnosing conditions and devising appropriate treatment therapies. Other software systems provide assistance in selecting appropriate tests and interpreting results.

As a further example, a law practice typically maintains information relating to: clients; matters being worked on for those clients; projects undertaken in connection with those matters; tasks that are necessary to complete those projects, and events relating to those matters and/or projects. These may include, without limitation: identifying and/or contact information for clients, potential clients, adversaries, counsel, foreign associate counsel, witnesses, vendors, experts, investigators, and others involved in the matter or project; billing information; documents, references, exhibits, and other records; email and other electronic records; fact and legal research; correspondence; pleadings; docketing; finance, budgeting, timekeeping, expense, billing, general ledger, accounts receivable, accounts payable, collection, and other financial data; and, potentially, a wide variety of other project management tools.

Document management and/or document assembly systems are typically employed in a legal practice to generate, maintain, manage, and retrieve work product. Many legal practices maintain “libraries” of prior work product, work flow forms, and/or “precedents.” These resources help maintain quality control, providing a knowledge base for training younger attorneys and efficiently generating work product. Graphics, modeling, presentation, and visualization tools are becoming more widely used. In addition, as in medicine, various expert systems are used, particularly in specialized areas of practice, such as litigation, securities, real estate, intellectual property, and others. More recently, the demand for case management systems has increased, particularly among in-house law departments. Case management systems known by the present inventor prior to the present invention, however, shared several of the deficiencies identified below.

Professional services practices typically maintain these types of information in various custom, proprietary, specialized, mass-marketed, and/or open software applications. These applications are not adapted to, and in many instances, are not capable of, cooperating or communicating with one another. Data, therefore, must frequently be converted or re-entered in various applications.

One of the greatest strengths of modern computer networks is their adaptability. They support a wide variety of different software applications and enable users to share work product. The users may be permitted to tailor their computing environment to their individual work patterns. This is highly desirable; yet, this pattern of individualized computing fosters a proliferation of software applications, operating systems, and network management applications. The architecture of computer networks has compounded the difficulties of managing these disparate systems.

Most networks combine various hardware components: personal computers; network and mainframe components; servers and routers; desk tops, laptops, and handhelds; remote access devices; personal digital assistants (PDAs); wireless access devices; various output devices, and a bewildering array of accessories. Each typically has a different operating system; of different vintage, quality, and capability. Apart from the substantial challenges this imposes on network managers and systems administrators, it has made the ready transferability of data between components more difficult, if not impossible.

In a typical law practice, for example, information systems and software may include, without limitation:

Hard copies of documents, files, specimens, and exhibits;

Physical exhibits and samples;

Electronic records;

Audio, video, voice mail, and other records;

Network Operating Systems software (typically some variant of Windows, i.e., 2000, NT, XP, 98, or 95; IBM OS2; Apple; etc.);

Records Management Systems (files, bar coding, indexers, or specialized records management applications);

Document Assembly Systems (such as “IPDAS” in an intellectual property practice setting, or other document assembly systems);

Document Management Systems (such as Hummingbird, PC DOCS, SoftSolutions; iManage; etc.);

“Knowledge Management” Systems (which are typically customized or proprietary software or some modified version of a Document Management System);

Email systems (ccmail, Notes mail, Microsoft mail, etc.);

Docketing systems (for example, CPI, Dennemeyer, IP Master; Patsy, IPPO, etc., for intellectual property practices; and other docketing systems for securities, tax, litigation, or other practice areas);

Word processing systems (WordPerfect, Microsoft Word, etc.);

Scheduling and calendaring systems (Lotus Notes, Microsoft Outlook, etc.);

Relationship Management and/or Contact Information (interAction; Outlook; Notes; Elite Apex; Aptus; customized or proprietary software; etc.);

Litigation Support (Summation; LiveNoteNideoNote; Access; CaseMap/TimeMap; Concordance; Trial Director; JFS Litigator's Notebook; Sanction; Folio Views; iConnect; DB Textworks; Isys; Introspect; BRS Search; RealLegal; E-tech; Ipro; etc.);

Electronic evidence service vendors (Ontrack; Electronic Evidence; Applied Discovery; Fios; Daticon; Deloitte & Touche; and others);

Electronic portals (such as those supplied by vendors such as SV Technology; Plumtree; Sequoia; and others);

Desktop fax software (RightFax; Legal Fax; and others);

Time entry systems (DTE; Carpe Diem; CMS Open; Elite; custom or proprietary systems; etc.);

Accounting systems (Elite; CMS Open; Elite for Windows NT; TMC; Rippe & Kingston; custom or propietary in-house; etc.);

Database applications (Lotus Notes, Microsoft Excel, Microsoft Access, Corel Quatro Pro, FoxPro, Lotus 123, Concordance, etc.);

Presentation applications (Microsoft PowerPoint; Corel Presentations; Sanction; Trial Director; etc.);

Project Management support systems (Microsoft Project; Project Gateway, etc.);

Critical path, probability assessment, and risk analysis tools (such as TreeAge software, etc.);

Various specialty applications (such as project management, flowcharting, PERT and GANT charting, budgeting tools, etc.);

Case Management systems (LawPack (Hummingbird); Corprasoft; Elite Information Group; Miratech; ProLaw (West Group); RealLegal; and PWC and other systems support vendors); and

A potentially a wide variety of other applications software.

Data accessed by these various applications may be maintained centrally, on a distributed basis, or in a combination of central and distributed database systems. Prior to the present invention, data was not readily transferable between the various applications used in a professional services practice. Co-pending U.S. application, Ser. No. ______, filed Dec. 10, 2002, which is incorporated herein by reference, includes a detailed discussion of the problems caused by the lack of portability and application-dependence of data of prior known applications.

There has long been an unresolved need for secure, reliable, simple data transfer between applications. Prior known approaches have failed to meet this long-felt and unresolved need, particularly in a professional services setting. The commercial software industry has long overlooked professional services markets. Professional services markets, therefore, have had to rely on either mass-marketed software applications that are not adapted to their particular needs, and/or customized and/or proprietary solutions that are expensive, complex, and limited in their flexibility and adaptability.

Neither centralized nor mass-marketed software applications have resolved these problems. Centralized applications have been applied in certain general business environments but have not been generally embraced by professional services markets. Applicant believes that this is due primarily to the personal and distributed nature of professional services, the need for flexibility and speed in professional services markets, and the high cost and inflexibility of large, centralized systems.

With respect to mass-marketed applications, users end up securing multiple, competing software applications. This results in duplication in purchasing and training, while only certain programs or features of each application are actually used. Although many mass-marketed applications advertise that they are “open,” they are fundamentally proprietary systems and are “open” only to the extent that the vendor has decided to enable development of certain compatible applications. These proprietary formats are generally not compatible with other software applications. Specifically, the data is not readily portable or application-independent. Even in those situations in which mass-marketed software applications have been marketed with the express representation that data is transferable between them (such as between Microsoft Word and Corel WordPerfect, or between various applications in a single manufacturer's suite of applications software such as Microsoft Office), typically, they are not.

Incompatibilities regularly cause catastrophic failures. The advent of Windows XP and other operating systems has not resolved these problems. These types of failures are unacceptable in a modern business environment. Instead, simplicity, transferability, speed, reliability, and security are required. Mass-marketed application software companies have not met these challenges. Instead they continue to supply software products that include known—and remediable—defects.

Incompatibility, flowing from the proprietary nature of various software platforms, ultimately requires that data be converted or that the same information be re-entered in multiple applications. This is wasteful and introduces multiple opportunities for error in data entry, maintenance, and retrieval. Proprietary software applications also require extensive investment in training, retraining, and support. Typically, the more powerful the tool, the more rigorous the training requirements. In a professional services practice, such as medicine or law, the individuals who could most benefit from these tools are the individuals whose time is most highly valued and whom the organization can least afford the extensive investment in training, retraining, and support time required to gain proficiency in multiple applications.

Ideally, the data used in a business should be exchanged on a commodity basis, the data should be portable or, preferably, application-independent. Although distributed PC-based networks could have fostered that result, they have had the opposite result. PC-based network systems have fostered the proliferation of incompatible, proprietary applications software. These proprietary systems have resulted in: maintenance problems; undue complexity in systems architecture and design; excessive network systems support requirements; the need for duplicate copies of applications software; increased systems maintenance; increased cost; impaired access to data; increased training time and expense; diversion of professional time to non-productive uses; and, ultimately, impairment of access to the information needed to run the practice or business.

None of the prior known approaches addresses the need to integrate and make more readily transferable the data used on a distributed basis in a professional services practice. Although the Internet has fostered the development of a series of protocols that enhance the transferability of data, such as POP (post office protocol), HTML (Hypertext Markup Language), XML (extensible Markup Language), WAP (Wireless Application Protocol), SOAP (Simple Object Access Protocol), and others, no consensus has yet emerged for standards or protocols for data used in a professional services practice.

Prior to the present invention, none of the systems of which the present inventor is aware facilitated the ready transfer of data between the various distributed applications used in a professional services practice. None provided data in a substantially portable or application-independent fashion. Moreover, none of the prior known approaches have resolved the unmet need to facilitate the transfer of data between outside professional service providers and their clients. Thus, there remains a long-felt and unmet need for a simple, efficient, and effective means for enabling data to be transferred between various software applications and computers in an internal and/or external network and, in particular, in the setting of a professional services practice.

### OBJECTS OF THE INVENTION

It is, therefore, an object of a preferred embodiment of the present invention to provide a case management software database application adapted to manage the data used in a professional services practice in a substantially application-independent, or at least substantially portable, fashion.

An additional object of a preferred embodiment of the present invention is to provide a Lotus Notes database case management application adapted to enhance the transferability and/or portability of data between or among various distributed applications of the types that are used in a professional services practice.

Another object of a preferred embodiment of the present invention is to provide a method for managing data used in a business and, in particular, in a professional services practice through a Lotus Notes case management database application.

A further object of a preferred embodiment of the present invention is to aggregate and/or integrate data used to manage professional services projects in a novel case management database format.

Additional objects and advantages of the invention are set forth, in part, in the description which follows and, in part, will be obvious from the description or may be learned by practice of the invention. The objects and advantages of the invention will be realized in detail by means of the instrumentalities and combinations particularly pointed out in the appended claims.

### BRIEF SUMMARY OF THE INVENTION

As illustrated in the accompanying diagrams and described in the accompanying claims, the invention is a method and system for improving the accessibility and transferability of various data and/or information resources used in the management of a business and, in particular, a professional services practice. Specifically, the present invention is preferably a Lotus Notes database adapted to integrate the data used in a professional services practice.

In a preferred embodiment, the present invention comprises an ODBC-compliant, Lotus Notes database, further comprising: Client Means; Matter Means; Project Means; Event Means; Task Means; and if desired, Document Means, Budgeting Means, Project Management Means, Assessment Means; and various alternative enhancements. In certain embodiments, Client Means, Project Means, and/or Activity Means may be provided. Alternatively, the present invention preferably comprises: Client; Matter; and Event Means. The invention may further comprise related information, data; and/or analysis, such as: communications; documents; forms; budget and/or cost information; project management; risk management; and other applications or information. The database of the present invention may be adapted to cooperate with other shared or linked data sources.

The present invention preferably comprises a data processing application, in machine readable form, for managing data relating to a professional services project, comprising: means for receiving the data in a format other than application-independent format; and storing the data in a substantially portable format. Alternatively, the present invention is preferably a data processing application, in machine readable form, for managing data relating to a professional services project, comprising: the application being adapted to receive the data in a format other than application-independent format; data storage means cooperating with the application for storing the data; the application being adapted to store said the data in a substantially portable format.

In an alternative preferred embodiment, the present invention is a data processing system for managing a professional services practice, in machine readable format, comprising: one or more distributed applications; data storage means, cooperating with said one or more distributed applications, for storing the data in a format other than an application-independent format; case management database means, cooperating with one or more of said data storage means and said one or more distributed applications; said case management database means being adapted to store said data in a substantially portable format; said case management database means being adapted to make the data available to users in the professional services practice.

In a further alternative embodiment, the present invention is preferably a data processing system for managing data relating to a professional services project, in machine readable format, comprising: the data being in a format other than application-independent format; one or more distributed applications; adapted to access the data; data storage means, cooperating with said one or more distributed applications, for storing the data in a format other than an application-independent format; server means, cooperating with one or more of said one or more of said data storage means and said one or more distributed applications, said server means being adapted to transfer the data; case management database means, cooperating with one or more of said server means, said data storage means, and said one or more distributed applications, said case management means being adapted for communicating with respect to the data; said case management database means being adapted to store said data in a substantially portable format.

Another alternative embodiment is preferably a user interface for a computer network comprising one or more distributed applications and data storage means used in a professional services practice, comprising: client means in machine readable format for aggregating data relating to the client for whom the professional services are being undertaken; matter means in machine readable format for aggregating data relating to the subject matter of the professional services; and project management means in machine readable format for aggregating data relating to the representation, the data aggregated in the project management means further comprising one or more types of data selected from the group consisting of: conflicts; accounting; docketing; word processing; document management; forms and prior work product precedents; workflow; events; tasks; risk management tools; project management tools; whereby the data is made available to the user.

In yet a further embodiment, the invention is preferably a method for aggregating project management information used in conjunction with a professional services practice, comprising: retaining client-related data associated with the client for whom the project is being undertaken in a first format; retaining project-related data relating to said client in a second format; retaining event-related data relating to the occurrence of one or more events associated with said matter in a third format; aggregating said client-, project-, and event-related data in machine readable format; and making said client-, project-, and event-related data available to the user in a common format. Alternatively, the method may further comprise: identifying a client associated with the data; identifying a matter associated with said client; identifying a project being undertaken on behalf of said client in conjunction with said matter; identifying docketing information associated with the project; identifying budget information associated with the project; identifying expense information associated with the project; identifying an event relating to said project; storing said expense information and said docket information in one or more first proprietary formats; transferring said client, matter, budget, expense and docket information to a second common data format; and providing said client, matter, expense, and docket information to a user.

Another alternative embodiment is a data processing application, in machine readable form, for integrating data relating to a professional services project, comprising: application means, for managing the data, said application means comprising client means for identifying the client, and project means for identifying the project; said client means further comprising data, maintained in a second application, relating to the client for whom the professional services are being performed, the data being selected from the group consisting of: identity of the client, relationships and affiliations of the client to other persons, client number, client contact information, lines of business, products and services, referral information, billing information, and fee-related information; and said project means further comprising data, maintained in a third application, relating to the subject matter of the professional services being performed, the data being selected from the group consisting of: identity of the project, creation date, description, geographic area, jurisdictions, other associate counsel, vendors, responsible attorney, comments, and other pertinent facts relating to the representation; said application means being adapted to maintain the data in substantially portable format.

In another preferred embodiment, the Lotus Notes database cooperates with an SQL server to draw pertinent information out of distributed proprietary applications used in the practice and supply it to the Lotus Notes database, from which it can be made available in portable or application-independent format, to users or other applications. The Lotus Notes database may thus serve as a data warehouse for the professional services practice, without the disruption of replacing the distributed proprietary application in use in the practice with a centralized data warehouse application.

It is to be understood that both the foregoing general description and the following detailed description are exemplary and explanatory only, and are not restrictive of the invention as claimed. The accompanying drawings, which are incorporated herein by reference and constitute a part of the specification, and in which like numerals are used to refer to like elements, illustrate certain embodiments of the invention, and together with the detailed description, serve to explain the principles of the present invention.

### BRIEF DESCRIPTION OF THE DRAWINGS

FIG. 1 is a flowchart depicting the interrelationship of various information resources and applications that may be used in conjunction with a database of a preferred embodiment of the present invention.

FIG. 2 is a flowchart depicting the flow of data and information between several of the data sources and applications in an alternative preferred embodiment of the present invention.

FIG. 3 is a flowchart illustrating the flow of various types of data into a single application in a legal practice, in a manner known prior to the present invention, illustrating the potential conflicts between multiple data sources for address information being supplied to the application, in this example, a word processing application.

FIG. 4 is a necklace diagram, depicting the flow of data from various data sources to a database of a preferred embodiment of the present invention.

FIG. 5 is a flowchart illustrating the flow of data between various proprietary applications of the type known prior to the present invention, in the setting of a legal practice.

FIGS. 6(a) and 6(b) are flowcharts illustrating the data structure of an alternative preferred embodiment of the present invention, adapted for management of a legal practice.

FIG. 7 is a flowchart illustrating the data structure of an alternative preferred embodiment of the present invention.

FIG. 8 is a flowchart further illustrating the data structure of an alternative preferred embodiment of the present invention.

FIG. 9 is a flowchart depicting an alternative preferred embodiment of the present invention, employing SQL server means to transfer data between data sources and a Lotus Notes database of a preferred embodiment of the present invention, showing the flow of data between various data resources and applications used to manage a legal practice.

FIG. 10 is an outline depicting the hierarchy of data of a preferred embodiment of an information management system of the present invention implemented through a Lotus Notes database.

FIG. 11 is a flowchart depicting some of the steps encountered in the course of a typically professional services representation.

FIG. 12 is a flowchart depicting a data structure and method of an alternative preferred embodiment of the present invention.

FIG. 13 is a flowchart depicting a data structure and method of an alternative preferred embodiment of the present invention.

FIG. 14 is a flowchart depicting a process for securing a U.S. patent.

FIG. 15 is a flowchart depicting a process for securing federal registration of a trademark in the United States.

FIG. 16 is a flowchart depicting the work flow process of a representative intellectual property infringement litigation matter.

### DETAILED DESCRIPTION OF PREFERRED EMBODIMENTS

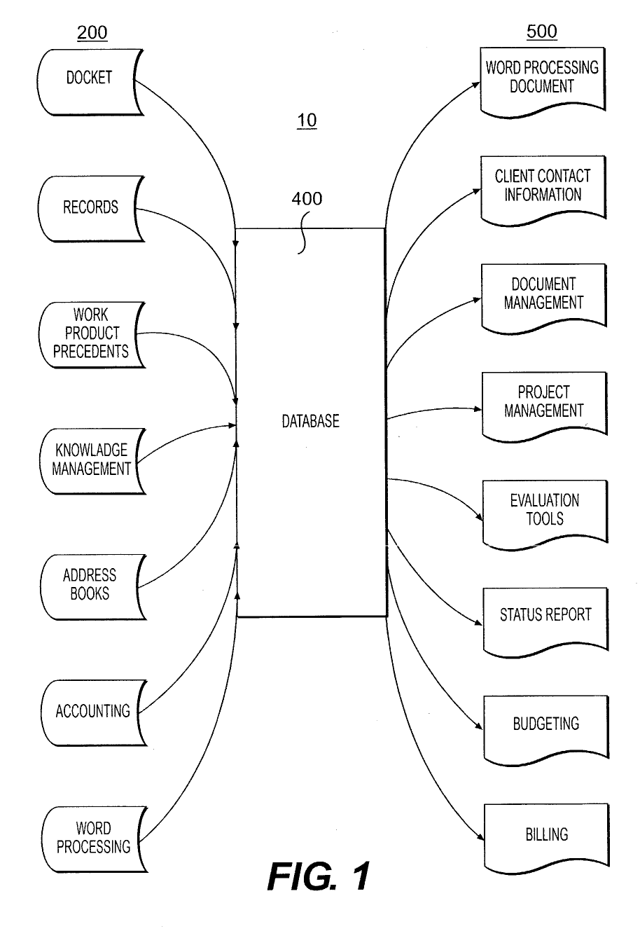

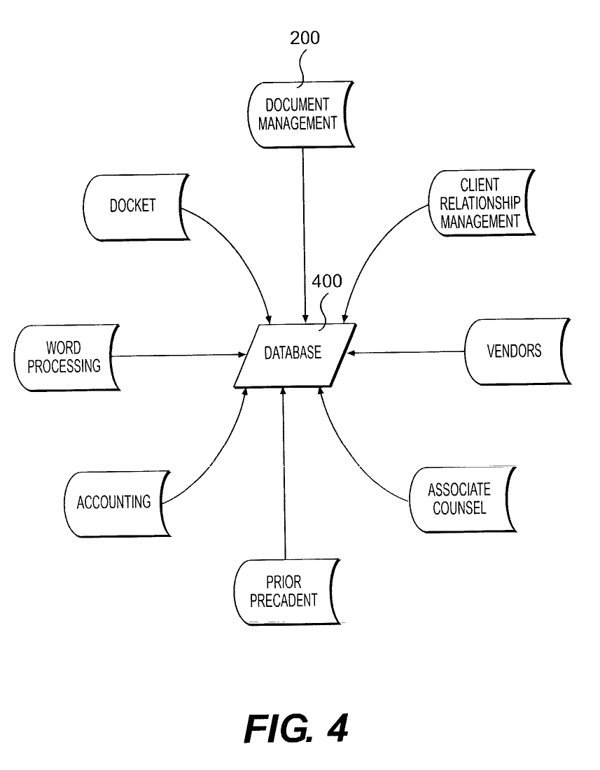

Reference will now be made in detail to alternative preferred embodiments of the method and system of the present invention, examples of which are illustrated in the accompanying drawings. A preferred embodiment of the present invention, in the setting of a law practice, is shown in FIGS. 1 and 4 as 10. In a preferred embodiment, the present invention comprises a database and method of use for aggregating and/or transferring data useful in the management of a professional services project or engagement. The present invention preferably provides a substantially portable or application-independent format for data used in a professional services practice.

The database of the present invention is illustrated in the setting of a law practice. It is intended, however, that the invention has wider applicability to other forms of professional services, such as medical practices, accounting practices, consulting services, and other professional services practices, as well as other business applications. The following detailed descriptions of various preferred embodiments, and examples of the invention, are illustrative and explanatory only and should not be construed to limit the present invention as disclosed and claimed.

The present invention preferably is embodied in an ODBC-compliant Lotus Notes database, cooperating with an SQL database which queries one or more “proprietary” distributed databases (such as a “proprietary” docketing, accounting, word processing, time and billing, etc., system). Attached to this application, as an Appendix, is a listing of the Forms from a Lotus Notes embodiment of a database of a preferred embodiment of the present invention. The Appended forms are incorporated herein by reference.

### “Proprietary,” “Common,” “Portable,” and “Application-Independent” Formats

For purposes of the present application, Applicant distinguishes between “proprietary” formats on one hand, and “common,” “portable,” or “application-independent” formats on the other. In principle, databases should be application-independent. In practice, however, databases are built for a specific application. Blaha, Michael, “A MANAGER's GUIDE TO DATABASE MANAGEMENT” (Prentice Hall 2001) at 3. Professional services practices rely on a variety of proprietary applications. Many are legacy systems in proprietary formats. Consequently, the data used in a typical professional services practice is substantially application-dependent. The data is not readily transferable or portable among applications.

As used in the present application, the terms “common,” “portable,” and “application-independent” are intended to convey a sense of the relative transferability of the data, and not an absolute or particular degree of transferability or application-independence. These terms are not intended to imply that the data is perfectly application-independent or completely fungible between software applications and/or operating systems, without error, modification, or adaptation. “Portable” formats preferably include standard such as ODBC: protocols and/or standards, either that are in existence today or that will be developed in the future. Application-independent formats include, without limitation, relational databases; SQL databases; and XML and HTML standards and protocols. Application-independent formats may also include various other web-enabled applications and protocols; SOAP; WAP; Open Source applications; Lotus Enterprise Integration; ZMerge; or other applications that are adapted to permit, facilitate, or enhance the transferability of data between applications.

The term “proprietary,” in conjunction with data formats of the present invention, refers primarily to proprietary software applications, of the types that are typically used in a law or other professional services practice. These may include, by way of example and not limitation, legacy systems and various hierarchical databases. The use of the term “proprietary” includes but is not limited to data that is entirely application-dependant or exclusive to a single application. Nor is it intended to convey an absolute sense of incompatibility or exclusivity. Rather, the term “proprietary” is intended to convey a relative degree of difficulty of transfer of data. For example, the relative degree of difficulty of transferring data from and/or among the various docketing and/or accounting applications of the type that were known in the legal market prior to the present invention is considered “proprietary.” Docketing systems (such as CPI, Dennemeyer, Master Data, Pattsy, or IPPO in an intellectual property practice), and accounting systems (such as Broadway, TMC, and/or Elite), prior to the present invention, had limited ability to transfer data to other applications used in the enterprise, such as word processing systems (such as WordPerfect and Word), document assembly systems, spreadsheets (such as Quarter, Excel, and Lotus 123), project management systems, and other software applications.

Although Microsoft and Corel each represented, prior to the present invention, that documents could be transferred readily between their respective word processing programs (Word and WordPerfect), errors and critical failures occurred frequently. Legacy knowledge bases in a prior version of a software platform are frequently lost upon conversion or upgrade, requiring costly and time-consuming efforts to convert individual documents and/or data to the newer release format. Although it may be possible to transfer data between these various “proprietary” applications, substantial effort is required to convert or transfer the data. These applications are not specifically designed to render the data readily transferable between them.

The term “proprietary” may be understood in some other settings to convey some claim of exclusive ownership, such as rights accorded by patent, trademark, copyright, or trade secret protection. The term “proprietary” as used in this application, however, is not limited to that sense of exclusive ownership rights but, rather, is used in the sense of the relative degree of application-dependence of the data. Formats that may enable a high degree of transferability and accessibility (such as .pdf, .tif, .jpg, and a wide variety of other data formats and protocols that are known in the art or may later be developed) may be “proprietary” in the sense that they are subject to claims of exclusive rights but should be considered to be “portable” in terms of data transfer and aggregation for purposes of the present invention. Similarly, proprietary applications may use relational or SQL databases, XML or HTML coding, and be considered application-independent in the sense of the present invention. Similarly, some “open source” software operating systems and/or applications may be public domain information in terms of ownership rights but may lack the requisite degree of data transferability.

Applicant considers application-independent data formats to be a preferred embodiment of the present invention. Nonetheless, the present invention may be implemented with “application-independent” or “portable” data formats, “proprietary” data formats, or some combination of them. Although the use of application-independent formats, such as relational databases, SQL databases, XML and HTML are within the level of ordinary skill in the art, these techniques have not been applied for purposes of the present invention, particularly in a professional services setting. In view of the lack of consensus standards, the invention is implemented in a Lotus Notes database in a present preferred embodiment. In certain preferred embodiments, a Lotus Notes database (which is ODBC-compliant), and/or SQL database, queries otherwise “proprietary” databases (such as a “proprietary” docketing, accounting, word processing, time and billing, etc., system). An Appendix is provided of the Forms implemented in connection with one embodiment of the invention in a Lotus Notes database format.

### Exemplary Embodiments

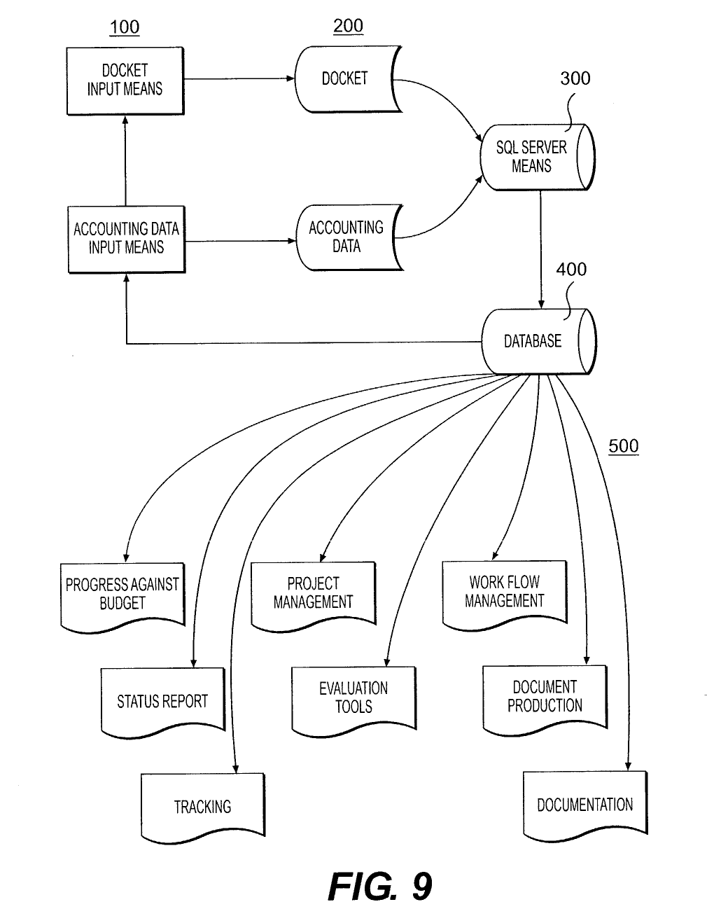

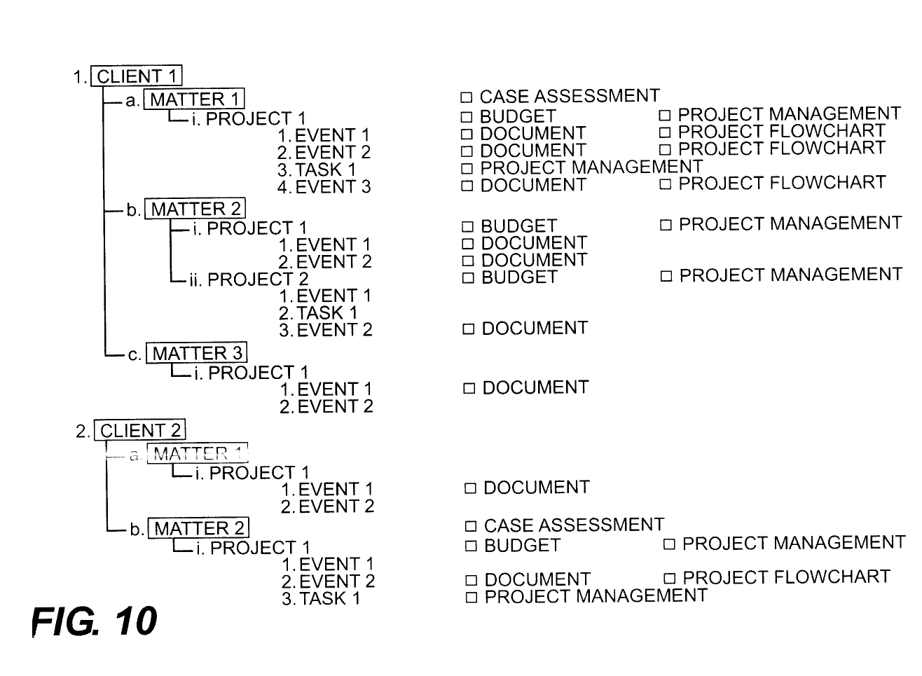

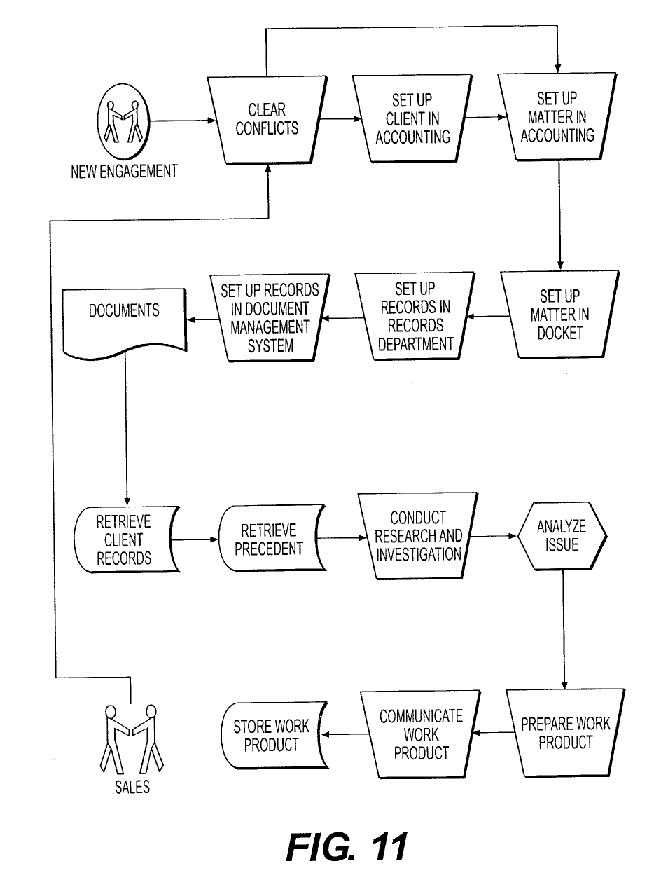

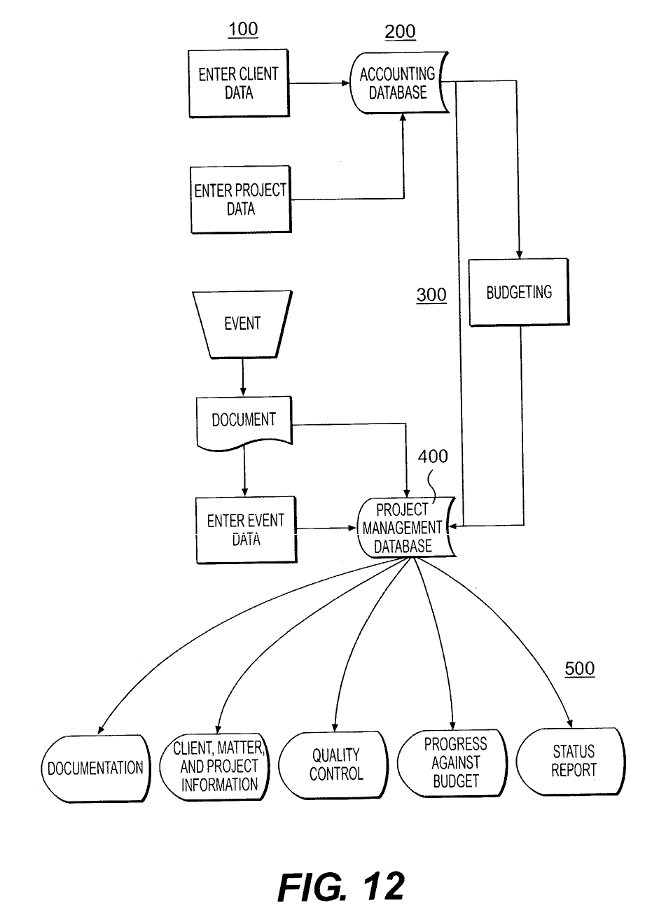

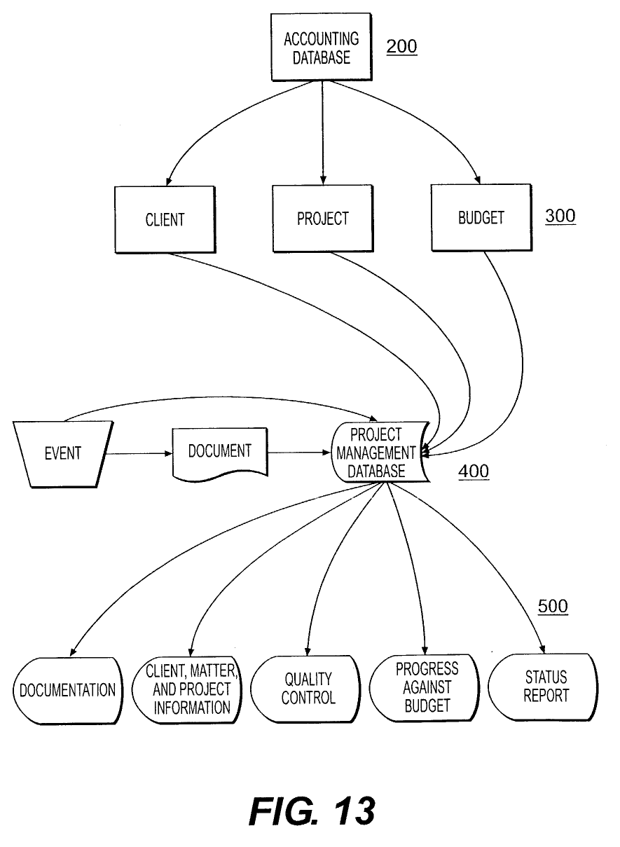

In a preferred embodiment of the present invention, as shown in FIG. 1, data 100 is transferred directly from the native applications 200 in which it is normally stored directly to a Notes database 400. Alternatively, as shown in FIG. 9, SQL server 300 periodically queries native applications 200 and secures data 100 from native applications 200 and transfers it to Notes database 400 from which it can be read or transferred to applications 500, or from which it can be transferred directly to the end user applications 500, in substantially “portable” or “application-independent” format. The Lotus Notes database can serve as a data warehouse for the professional services practice or may be used in conjunction with another data warehouse.

Data means 100 comprises data used in the business or professional services practice. Data means 100 preferably further comprises data in a “common” or substantially “portable” or “application-independent” format. Common data formats may include portable formats, such as various ODBC-compliant formats. Common formats may also include substantially application-independent formats such as: relational databases, SQL databases, and various web-enabled formats (such as ip, tcp/ip, ftp, http, HTML, XML, and other web-enabled formats). It is intended that the common data formats of preferred embodiments of the present invention comprise any suitable format that is adapted to support transfer of the data in a substantially portable or application-independent manner.

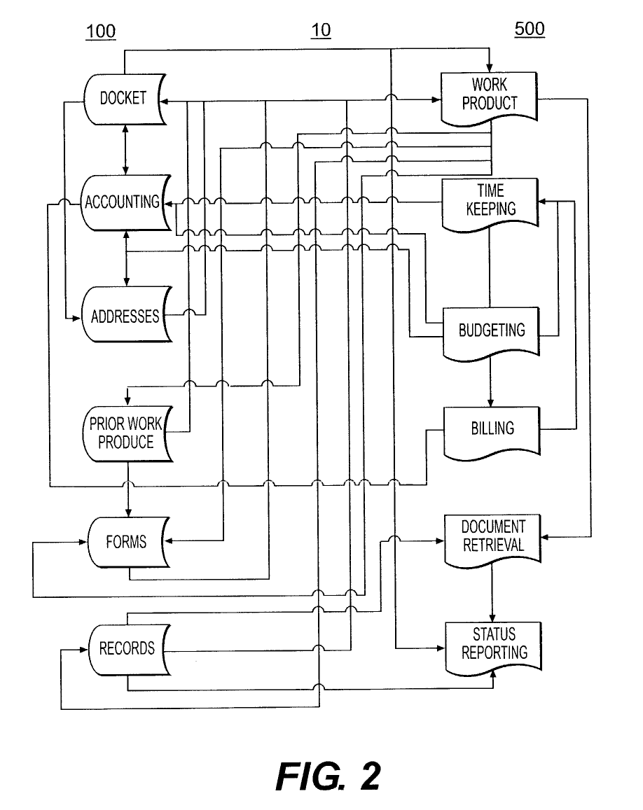

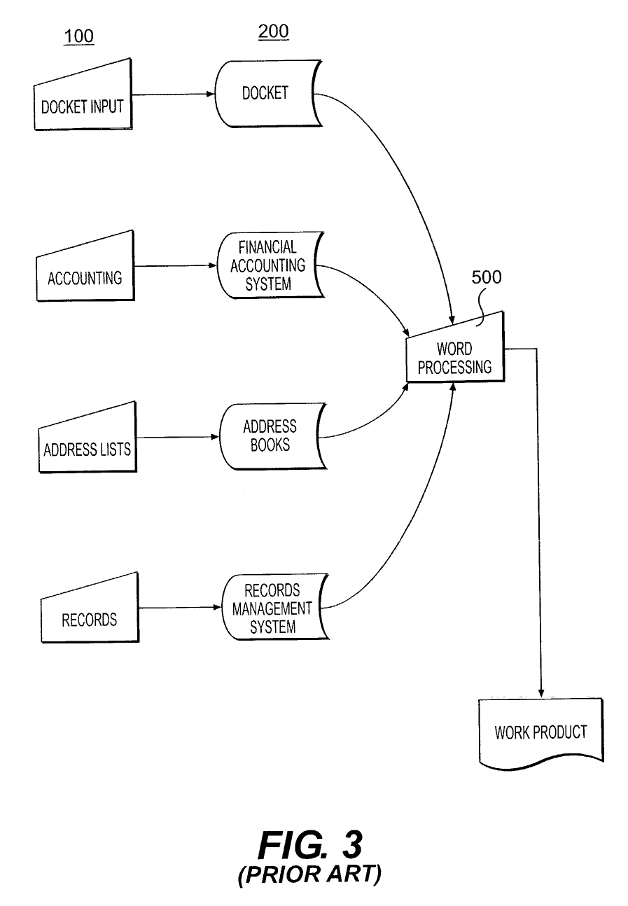

In a preferred embodiment, data means 100 may be maintained in a proprietary data format, in which it can be transferred among the various distributed applications, as shown in FIG. 2. Data means 100 preferably further comprises methods, processes, or systems, for securing the data, such as key entry, voice recognition, optical scanning and/or imaging, data transfer, reading data from any medium, or any other suitable techniques.

In a preferred embodiment, data means 100 comprises: client means, matter means, and event means. In alternative preferred embodiments, data means 100 further comprises any one or more of the following: project means; task means; documentation means; budget means; expense means; project management means; project evaluation means; and other data. Illustrative Forms for each type of entry as the data are input into a Lotus Notes database of a preferred embodiment of the present invention are provided in the accompanying Appendix.

### Client Means

Client Means preferably comprises data about the client for whom the project is being performed. Client data means typically are maintained in a docketing and/or accounting system. The client is established as a client of the firm, after conflicts have been cleared with respect to the representation. The data may be key entered into the accounting system and preferably transferred to the docketing system and other software applications in which the data is needed, such as word processing and/or address books, or vice versa. Prior to the present invention, the data was typically key-entered separately into each application (conflicts, accounting, docketing, word processing, time and billing, etc.) in which it was needed.

In an alternative preferred embodiment of the present invention, Client means further comprises one of more of the following: Bibliographic Information; and Service Provider Information. Bibliographic information preferably comprises one or more of the following: Client Name; Client Number; Primary and Supplemental Contact Name(s) and Address(es); Client's Line of Business; Client's Products/Services; and/or any other pertinent information. In an alternative preferred embodiment, Service Provider Information further comprises Attorney Information. The Attorney Information preferably comprises one or more of the following: Referral Information; Originating Attorney; Billing (or Client Relationship) Attorney; Supervising Attorney; Working Attorney(s); Billing Arrangement; Billing Rates; Alternative Fee arrangements (if any); and any other client of the firm to whom the client is related.

### Matter Means

Matter Means comprises data about the matter for the client for whom the project is being performed. Matter data means typically are established in the same fashion as client means. Address information is typically linked to a client and/or matter. Thus, while the project is proceeding, client means, and/or matter means are preferably available and client data means, address data means, and matter data means, are coordinated between accounting, docketing, address, and other applications in which the data is needed.

Matter Means preferably further comprises one of more matters adapted to the professional services being rendered by the professional services firm to the client. For example, in the setting of an intellectual property law practice, matter means may comprise any one or more of the following types of matters: Patent; Trademark; General Counseling and Advice; Administrative Proceedings; Litigation; Licensing and Agreements; and matters for specific third parties.

Matter Means tracked by the present invention preferably includes any one or more of various data about the matter, including without limitation: Matter Name; Matter Number(s); Description; Matter Creation Data; Responsible Professional; Billing Contact(s) for that matter; any related documentation (including images); Powers of Attorney; pertinent contacts; and pertinent details about the matter. Client Name and Client Number information is preferably adapted to be transferred automatically to the Matter Means, to avoid the necessity of key entry or manual transfer of the data.

### Project Means

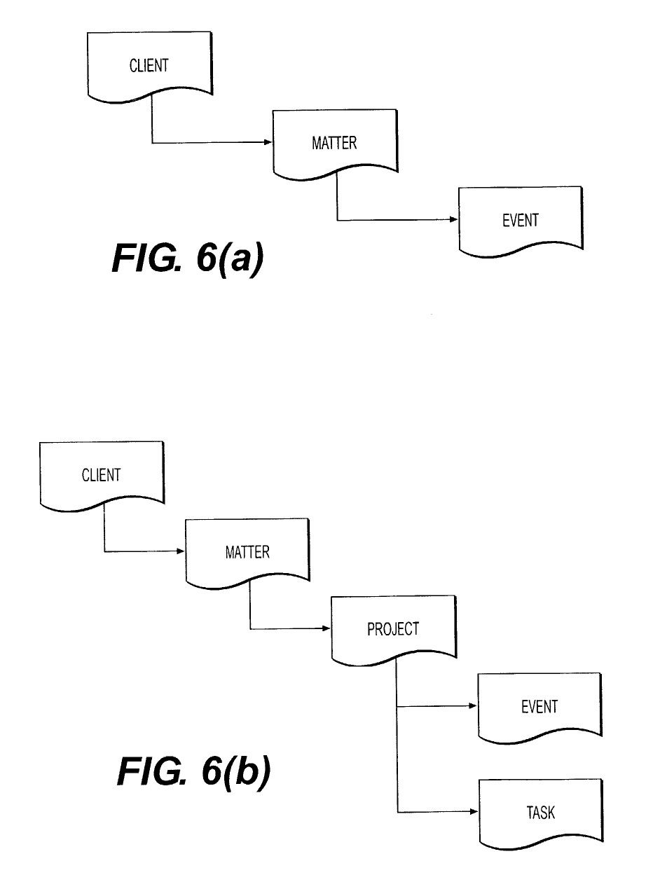

Project Means may be used to identify multiple projects that are being carried out in conjunction with the same client and/or matter. Project Means preferably differentiate between multiple projects under the same general matter. Projects may be aggregated under Client Means, Matter Means, or both. Alternatively, Project Means may be omitted (FIG. 6(a)) and project level information maintained at the Client and/or Matter level.

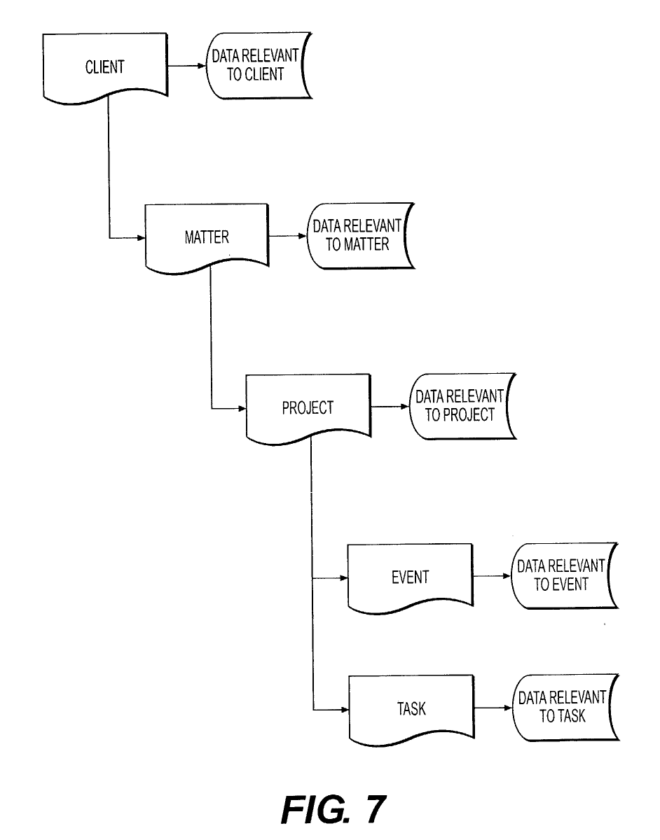

For example, Project Means may be identified at the Client level (FIG. 6(b)), enabling multiple matter numbers to be issued for the same project in the accounting and/or docketing systems. Alternatively, Projects could be identified at the Matter level (FIG. 7), enabling multiple projects to be identified for the same matter in the firm's accounting and/or docketing system. Similarly, projects could be identified at both the client and matter levels, if desired. This flexibility enables the user to more precisely track activity or tasks in conjunction with rendering the professional services.

Project Means tracked by the present invention preferably include various data about the project, including without limitation: Type of project; Identifying numbers or codes; Description of the project; Country and Foreign Associates; Addresses; Comments; any Related Documentation; Affiliated Parties; Counsel, Courts, and Administrative Tribunals; Case Numbers; Responsible Person(s) or Person(s) related to the project; Serial Numbers; any pertinent information related to any applications, registrations, or grants; Transfer information; Pertinent Dates; any other suitable information relating to the project. In alternative preferred embodiments, Project Means is further adapted to cooperate with Client Means, Matter Means, Event Means, or said Task Means, or is subsumed within or merged with said Matter Means.

### Event Means

Event Means preferably comprises data about significant events relating to the professional services being rendered. Event Means may comprise: Official Communications from Government Agencies, Orders, Motions, Notices, and any other pertinent events. Event Means may be maintained in any of the various native applications employed in the enterprise. An event may be recorded in the Docket, in physical records, or in an application specifically developed to support and record events. Alternatively, events may be recorded in any other suitable application.

Event Means tracked by the present invention preferably include any one or more of various data about any significant event in conjunction with the project, including without limitation: Event Date; Date that the event record was created; Identification of the event; Description; Assessment of its impact; Milestones achieved or implicated by the event; Responsible professional; Routing information; and any other pertinent information about the event. Event Means may further comprise information relating to retirement of the event.

The Client Name, Client Number, Matter name and Matter number information preferably is adapted to be supplied to the Event Means automatically, without requiring additional key entry or transfer of data by the user.

### Task Means

Task Means preferably comprises data about the task being performed. Task Means may track specific items of work that may be conducted in conjunction with rendering the professional services. Task Means tracked by the present invention may include any of various data about tasks relating to the services, including without limitation: Identification of the task; Description; Task Creation or Assignment Date; Due Date; any Milestones; Estimated time and resources to complete the task; Priority; to Whom the task has been assigned; Routing; and any other pertinent information about the task.

Task Means preferably are dependant from Matter or Project Means, at the same level of dependency as Event Means. Task Means preferably further comprises information relating to closure of the task.

The present invention preferably is adapted to enable Client Means, Matter Means, Project Means, and Event and Task Means to cooperate with one another and/or one or more external applications to facilitate transfer of data. For example, the Client Name, Client Number, Matter Name, and Matter Number information of the Client Means and Matter Means of the present invention preferably are transferred and automatically posted to the Event and Task Means of the present invention. Further, data is preferably transferred from one or more applications external to or cooperating with the present invention.

In alternative preferred embodiments, the present invention may further comprise one or more of: Documentation Means; Forms Means; Budget Means; Expense Means; Project Management Means: Project Evaluation Means; and Report Means. Each may cooperate with one or more of: Client Means, Matter Means; Project Means; Event Means; or Task Means.

### Documentation Means

Documentation Means may be provided to enable access to documents relating to the Project through the common data format interface, without having to separately access the records in their native application or through a document management application. Documentation Means preferably includes links to several of the available documentation relating to a project, including without limitation: indices or summaries; document management system; document assembly system; links to the document(s), copies of the documentation in a common or different data format; or any other information about documentation desired by the user.

In a preferred embodiment of the present invention, Document Means further comprises an icon or link, in the Event Means or other field, to the document in a portable or application-independent format (such as an ODBC, relational databases; SQL, XML, HTML, tif, .jpg, or .pdf file); over the Internet, an extranet, or intranet; a link to the document in a document management system in its native format; or other suitable means adapted to facilitate access to the document.

### Forms Means

Forms Means may be provided to enable access to forms or work product precedents relating to the Project through the database. Alternatively Document Means may further comprise forms or precedents useful in the practice. These forms may be embodied in sample matters for that type of project, appended as forms in a shell format to matters of specific types, or otherwise made available to professionals working on a matter. Preferably the forms are made available through the database of the present invention, without having to separately access the records in their distributed native application or through a separate document management or document assembly application. Alternatively, the database of a preferred embodiment of the present invention may comprise links to these other distributed systems.

Forms Means preferably is adapted to certain milestones or Event Means that typically involve the preparation of certain forms in response. Once the milestone or event has been reached, the system preferably accesses the appropriate form. This access may include links to pertinent forms, including without limitation: indices or summaries; address information of the document in document management or document assembly systems; automatic assembly of the completed from data available in the system of the present invention; links to the form document(s); copies of the forms in a common or compatible data format; or any other information about form(s) desired by the user.

### Budget or Time and Billing Means

Budget Means may be provided to identify projected and actual budget performance for the project. Some of the tools that may be used in conjunction with the present invention preferably include, without limitation: Tables; Schedules; Spreadsheets; Databases; Graphs; Indicia; Icons; and any other means adapted to provide budget information for a project or matter. Budget Means of the present invention may take any format suitable for use in conjunction with the system for providing useful budgeting information. Budgets could be tracked separately by expenses and fees, as well as at various discrete stages of the project.

In the context of rendering legal services, various types of budgeting software are generally used, including without limitation: TMC; Elite; Broadway, CMS Open; and various others. Some of these software systems include budget modules or budget functionality that may be adapted for use in conjunction with the present invention. These prior systems, however, have been hampered by their inability effectively to deliver budgeting data to the user in a format in which it can readily be used or manipulated, such as Excel spreadsheets. It may be necessary, therefore, to export the data from these financial accounting software packages to other format(s) from which it can be used more effectively in management of the professional services practice. This export can be accomplished by dumping the data to spreadsheets adapted to cooperate with the system of the present invention through VLOOKUP Tables, SQL queries; or any other suitable means.

Data may be exported in particular format(s) so that they can be read by or transferred to the system and method of the present invention. Alternatively, data may be exported directly to the system to the present invention or to an intermediate database. Suitable databases could include: Crystal Reports; Excel; Notes; SQL; Windows—compatible; Cold Fusion; HTML; XML; relational databases; ASCII; ODBC-compatible; or any other format, that is adapted for use in conjunction with the system and/or method of the present invention.

For example, using a TMC Accounting system, the invention may export: Default budgeting information from the TMC system; Monthly Fees; Monthly Expenses; Accrued Fees (from inception, year to date, or other suitable period or by category), and/or Accrued Expenses (from inception, year to date, or other suitable period, or by category).

In the context of an intellectual property practice, for example, budgets could be established for any one or more of the following: Preliminary Patentability Assessment; Patent Application Preparation and Prosecution; Trademark Clearance; Trademark Application Preparation and Prosecution; Copyright Application Preparation and Prosecution; Opinion of Counsel; Patent Infringement Litigation; Trademark Infringement Litigation; Copyright Infringement Litigation; Patent Cooperation Treaty filings; Foreign Trademark Application filings; and any other project suitable for determination and tracking of a project budget.

Each of these categories of project types may be further defined based on the complexity of the project. For example, in a preferred embodiment of the present invention budgets are prepared based upon a simple, intermediate, or complex level of effort for patent infringement claims or patent preparation and prosecution. Similarly, varying levels of budgeting could be offered to the user based upon the complexity of a trademark infringement claim, or other projects.

Budget Means tracked by the present invention preferably includes variations of the budget and expenditure information about the project, including without limitation: estimated budget(s) for the project; breakdown by stages; fees and expenses; accrued costs; payables information; accounts receivable information; graphical comparisons of projected budget and actual expenditures; and any other information desired about the financial performance of the project.

In alternative preferred embodiments of the present invention Budget Means further comprises a graphical interface for indicating to the user the budget for the project relative to the accrued fees and expenses to date. This can be accomplished through any suitable graphical interface, such as the silo format, employed in many video games for depicting resources relative to expenditures, or other suitable format.

### Project Management Means

Project Management Means may be provided to enhance management of the professional services project. Links to tools such as Microsoft Project and/or Project Gateway databases that provide project management tools may be adapted to cooperate with the aggregated data.

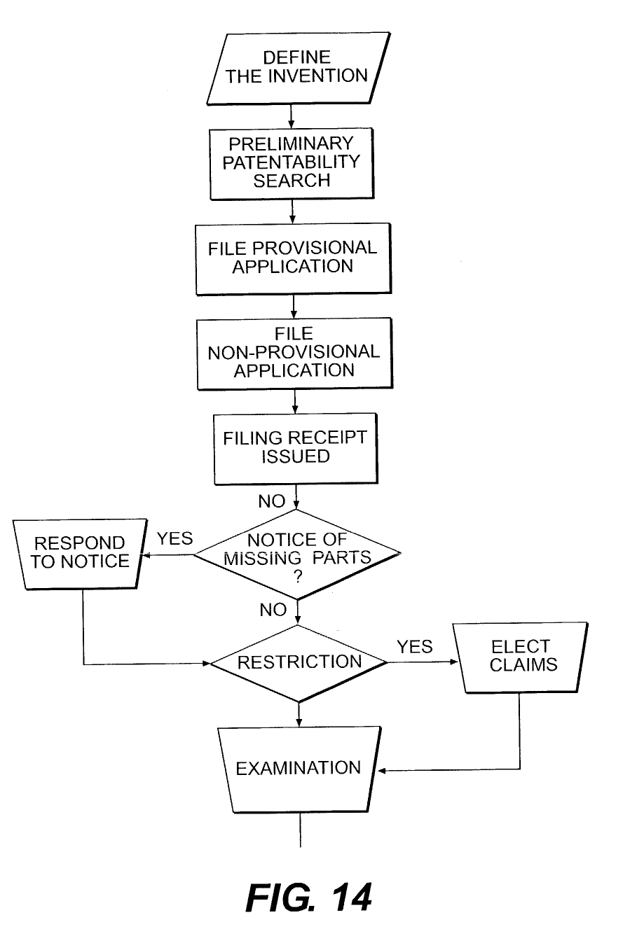

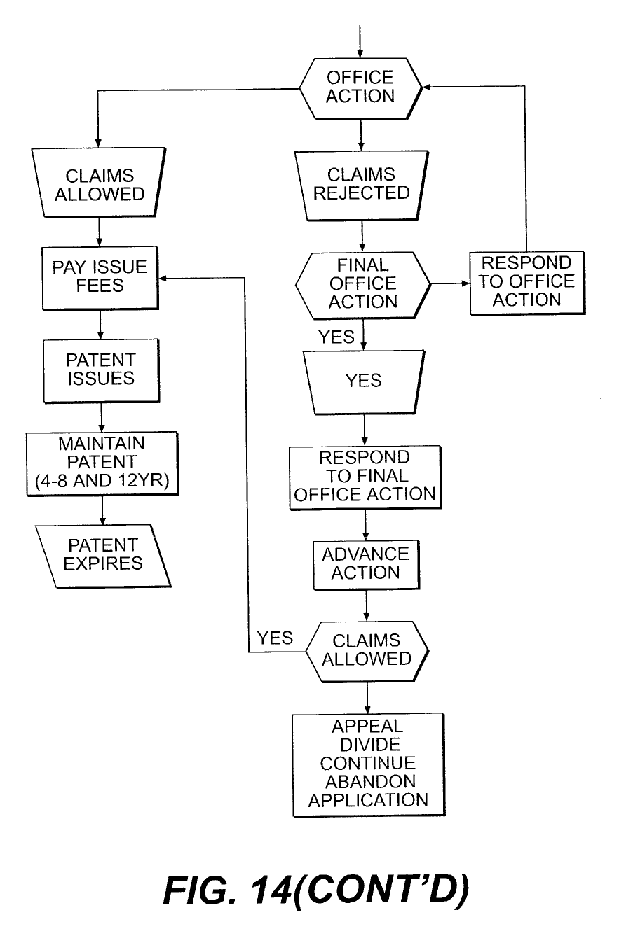

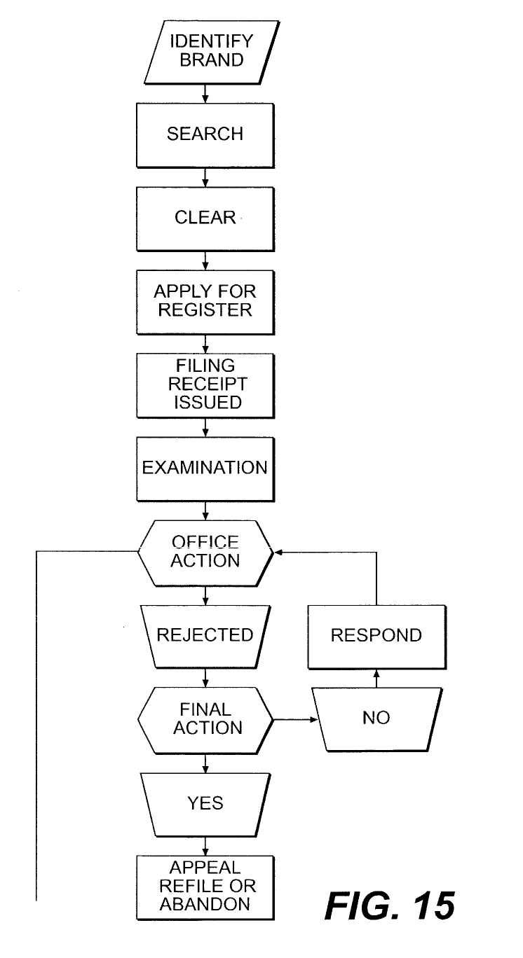

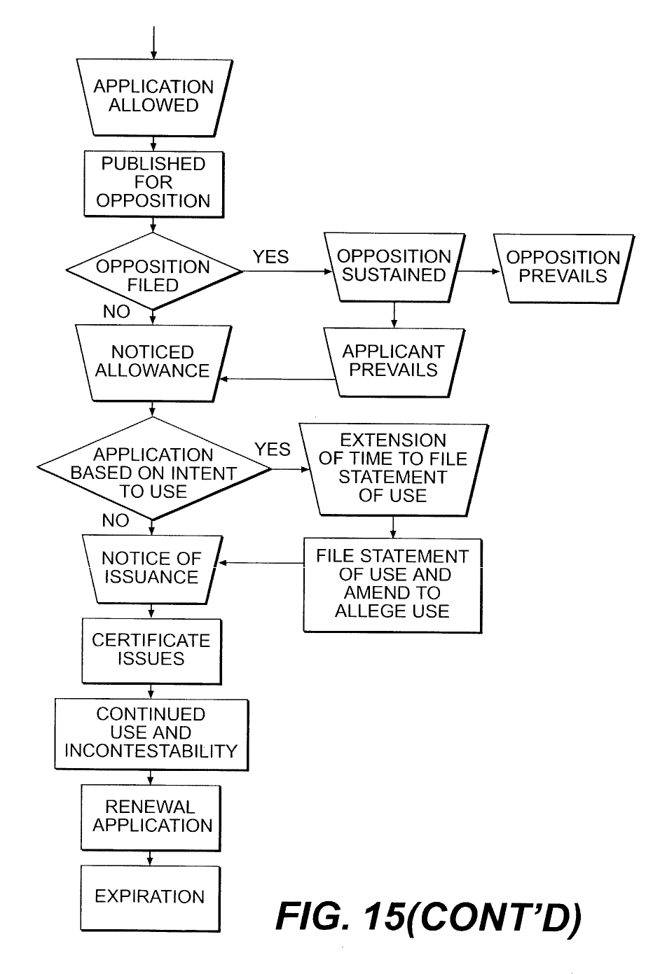

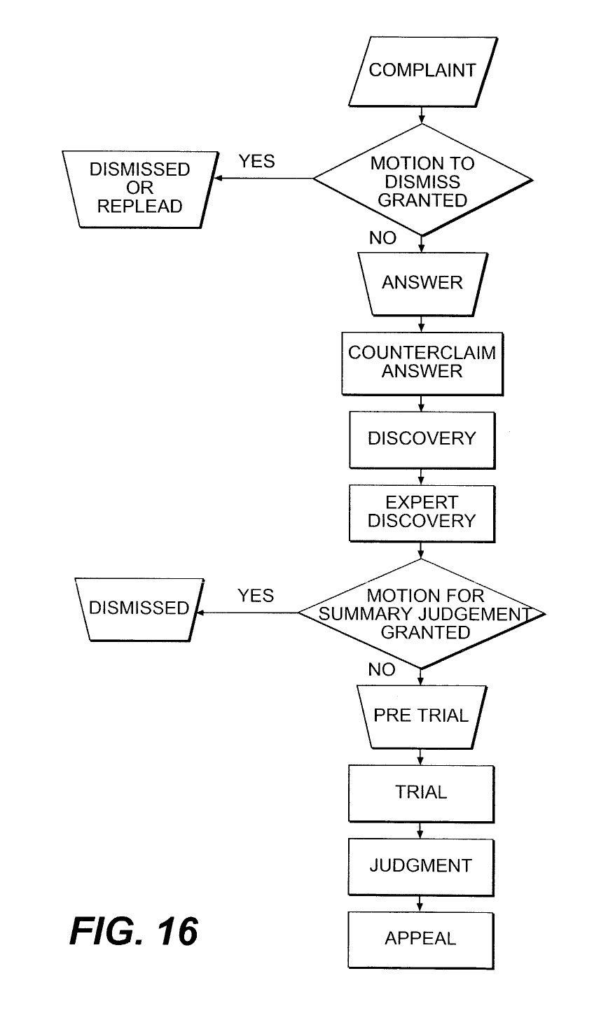

In alternative preferred embodiments, flowcharts may be provided of the steps being performed in conjunction with the project. FIGS. 14-16 illustrate sample flowcharts for a patent prosecution, counseling and advice, and litigation matters, respectively. The flowchart is preferably colored, illuminated, or provided with any other suitable indicator of the progress of the project. In preferred embodiments of the present invention these milestones may be keyed to certain event means achieved during the course of the project.

### Project Evaluation Means

Project Evaluation Means may be provided to assess the project. Risk assessment tools, such as litigation risk management tools, decision tree tools, and various other tools could be provided and/or adapted to the aggregated data. For example, TreeAge or other suitable risk assessment software may be coordinated with the present invention to cooperate to provide project evaluation tools based upon the aggregated data.

### Reporting Means

Reporting Means may also be provided to enable the project manager to “slice and dice” the aggregated data in various ways to create and prepare various assessments. In preferred embodiments of the present invention, it may be desired to summarize the data in Excel spreadsheets or other suitable summary formats. In a preferred embodiment of the present invention, reporting systems, such as Crystal Reports, can be adapted to provide the reporting function of the present invention.

### Data Transfer Means or Data Warehouse

The present invention may be implemented in a separate software application, such as a database or data warehouse running in Lotus Notes or other suitable application, or through direct transfer of the data 100 from the native applications 200 to the end use application 500, as needed. If implemented through a separate project management database, it may be desired to transfer certain data from applications in which it is native, such as a docketing or accounting system, to the project management application 400.

The data may be drawn from the docketing application as it is entered and published to the Notes application, as a result of periodic SQL server queries, and transferred to the project management application, or through any other suitable means.

### Notes Project Management Database System

The system and method of the present invention are preferably implemented through a personal computer-based system, operating in a network environment, using local and wide area network server technology of the type well known in the art. In a preferred embodiment, the system of the present invention is preferably implemented on Novell network, with database 400 running on a Lotus Notes server, cooperating with an SQL server 300 in communication with various servers, routers and network components on which the software applications are maintained, to facilitate access to various documentation, docketing, accounting, budgeting, and billing information as desired.

The present invention may be implemented through various alternative software and/or hardware systems, including, without limitation: data standardization; Lotus Agenda; Lotus Notes; Lotus Notes in conjunction with an SQL Server; Java; and various Web-enabled protocols. Thus, it is intended that the invention is not limited to any particular hardware or software application(s) or implementation.

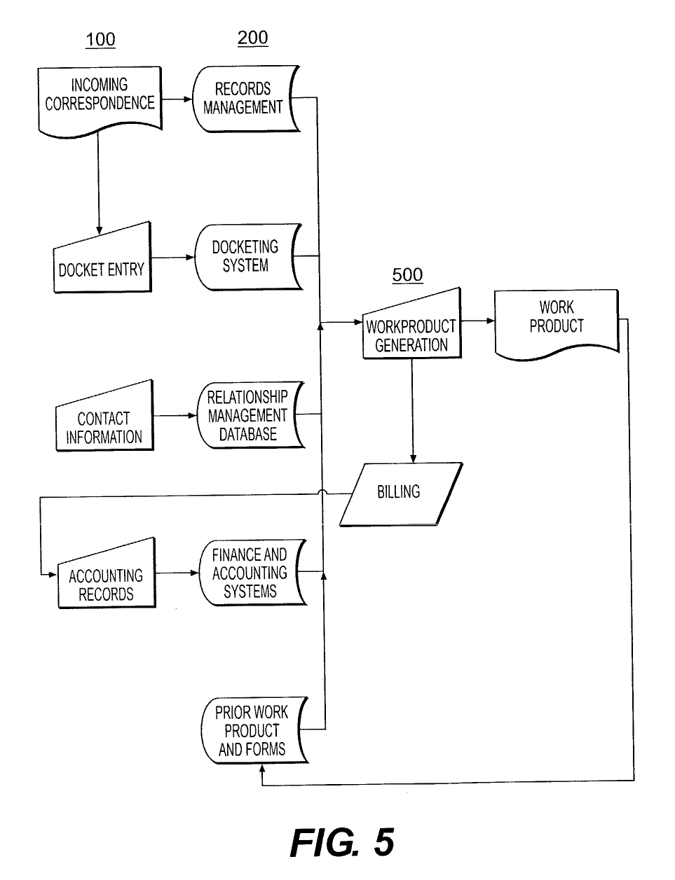

In an alternative preferred embodiment, as shown in FIG. 5, data means 100 is maintained in various data storage means 200 and application means 500: docketing data in a proprietary format such as CPI; accounting data in a proprietary format such as TMC; records in physical (paper) copies, email (ftp, ip, html, xml or other web enabled formats), and/or electronic image files (.tif, .pdf, .jpg and other formats), and related indices (document management systems such as DocsOpen); Address Books in a relationship management system (such as Notes Address Books, Rolodex, iEnterprise or other relationship management software); Word Processing and Work Product in word processing applications (Word and/or WordPerfect) and related indexing systems (such as DocsOpen or SoftSolutions); presentation tools (such as PowerPoint and Corel Presentations); and evaluation tools (such as Excel, Corel Quatro Pro, TreeAge decision tree software and other risk evaluation tools). Some of these formats are common (relational databases, SQL databases, HTML, and XML), while others are proprietary (CPI, TMC, Microsoft Word, Microsoft Excel).

To the extent the native application formats, although proprietary, are compliant with a common data standard, such as ODBC, the data may be transferred to a database or the project management application of the present invention. Alternatively, when the native application format(s) are incompatible, the data may be retrieved through queries of the type well known in the art (such as SQL queries), converted, and exported to another database in which it can aggregated or integrated with other data. Alternatively, the data may be exported then converted once in database 400.

These conversions and transfers are carried out in a manner well-known in the art. Michael Blaha, in his book, “A MANAGER'S GUIDE TO DATABASE TECHNOLOGY” Prentice Hall (2001), which is incorporated herein in its entirety by reference, describes several approaches to database design and development. These, and other techniques would be within the level of ordinary skill in the art in implementing the present invention.

For example, as shown in FIG. 9, the data may be exported from the various native applications to a SQL data base, the SQL database can be queried, and the data transferred to the project management application database 400. Persons of ordinary skill in the art would readily appreciate the various alternative means for implementing the invention as described in this application.

Data storage means 200 preferably comprises data storage systems of the type well-known in the art. This comprises any one or more of: hard drives; network drives; floppy or zip drives; tape or disc drives; any other suitable optical, magnetic, or other memory; or various types of data storage devices. Alternatively, by employing common data formats or proprietary formats that are adapted to transfer information to common formats, it may be possible to eliminate the use of physical storage devices and access the information directly from its source, as needed. The invention, therefore, preferably further comprises data transfer means 300 for transferring the data from its source to the application(s) in which it is used.

Thus, data storage means 200 and/or data transfer means 300 are intended to comprise the various hardware, software, and operational techniques that enable transfer of and access to the data, as needed, whether in “real time,” near real time, or on a predetermined schedule, as the data is needed, or through the use of any of the various storage means that are well known in the art. For example, data transfer means 300 may comprise a SQL server, adapted to receive data from one or more native applications and delivering the data to a Notes database.

Database means 400 is preferably a case management database, adapted to integrate and display the aggregated information. In a preferred embodiment of the present invention database 400 may be a Notes database adapted to receive data means from various data storage means 200 or data transfer means 300. Data preferably is received in database 400 in common and/or proprietary formats, and made accessible to the user through database and one or more application means. The data may be converted from its native format into a common format, retained in one or more of the native formats, converted to one or more proprietary and/or common formats.

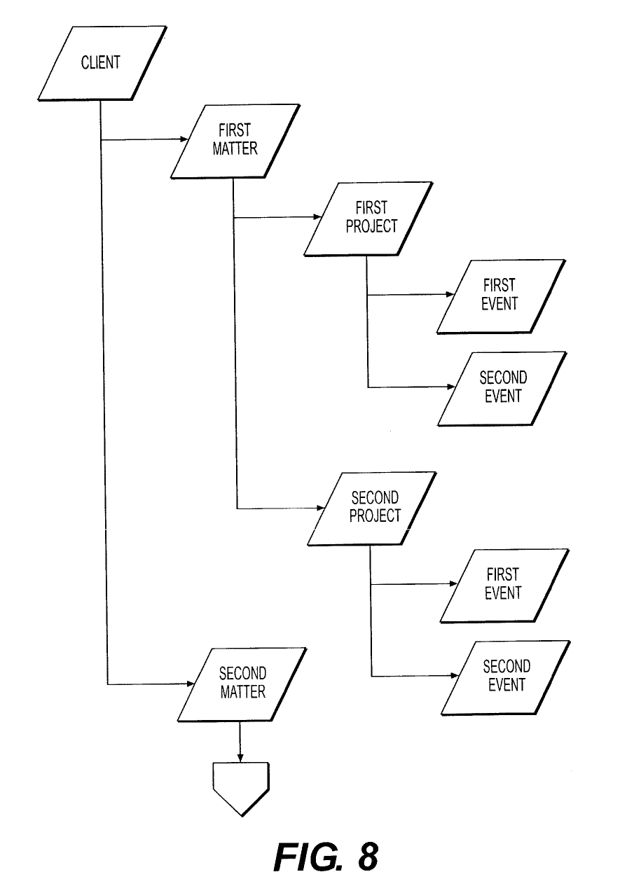

As depicted in FIGS. 6(a), 6(b), 7, and 8, for various preferred embodiments of the present invention, the hierarchy of database 400, may be: (1) Client Means; (2) Matter Means; and (3) Event Means (FIG. 6(a)). In an alternative preferred embodiment, the hierarchy may be: (1) Client Means; (2) Matter Means; and (3) Event Means and Task Means. Alternatively, the hierarchy may be (1) Client Means; (2) Matter Means; (3) Project Means; and (4) Event and Task Means (FIG. 6(b)). In further preferred alternative embodiments, the hierarchy may be: (1) Client Means; (2) Project Means; (3) Matter Means; and (4) Event and Task Means.

Application means 500 comprise any of the various applications that are typically used in a business and, in particular, in a professional services practice. These may include, in the example of a law practice: word processing; document assembly; document management; time keeping; accounting; cost recovery; budgeting; billing; document retrieval; work product precedents; forms; evaluation tools; spreadsheets; docketing systems; legal research systems; statutory, regulatory, and case law precedents; legislative and/or regulatory tracking systems; specialized knowledge systems for various types of practices; and various other applications.

It will be apparent to persons of ordinary skill in the art that various modifications and variations may be made in connection with the database of the present invention, without departing from the scope of the invention as claimed. For example, the invention may be implemented with any suitable data storage and/or transfer means. The order of the steps, and in particular storage and transfer of the data are not critical. Data may be stored in the native application and accessed as needed. Alternatively, data may be stored in a portable or application-independent format. Further, data could be accessed by the application either as needed or on the basis of periodic updates and stored in the application being used to display the data. Thus, the order of the steps and the specific location where any one or more of the data means are stored are not critical. The data desired need only be available when needed.

It will be apparent to persons of ordinary skill in the art that variations and modification may also be made to the method of the present invention. For example, the order of steps in the process of the present invention, the particular hardware and software implementation are not critical. The present invention is also preferably adapted to track and manage quality control systems for the management of business processes other than a professional services practice. Thus, it is intended that the variations and modifications of the invention and its components are considered part of the invention, without departing from the scope or spirit of the invention as disclosed and claimed, provided they come within the scope of the appended claims and their equivalents.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

I claim:

1. A data processing application, in machine readable form, for managing data relating to a professional services project, comprising:
a. means for receiving the data in a format other than application-independent format; and
d. storing the data in a substantially portable format.

2. The application of claim 1, wherein the application is adapted to provide the data in substantially portable format to other applications.

3. The application of claim 1, wherein the application is adapted to provide the data in substantially portable format to a user.

4. The application of claim 1, wherein the application is a database application.

5. The application of claim 1, comprising ODBC-compliant database means.

6. The application of claim 1, comprising a shareware database.

7. The application of claim 1, comprising a Lotus Notes database.

8. The application of claim 1, in which the application is adapted to store the data in a portable data format.

9. The application of claim 1, in which the application is adapted to store the data in application-independent format.

10. A data processing application, in machine readable form, for managing data relating to a professional services project, comprising:
a. the application being adapted to receive the data in a format other than application-independent format; and
b. data storage means cooperating with the application for storing the data;
c. the application being adapted to store said data in a substantially portable format.

11. The application of claim 10, wherein the application is adapted to provide the data in substantially portable format to other applications.

12. The application of claim 10, wherein the application is adapted to provide the data in substantially portable format to a user.

13. The application of claim 10, wherein the application is a database application.

14. The application of claim 10, comprising ODBC-compliant database means.

15. The application of claim 10, comprising a shareware database.

16. The application of claim 10, comprising a Lotus Notes database.

17. The application of claim 10, in which the application is adapted to store the data is a portable data format.

18. The application of claim 10, in which the application is adapted to store the data in a substantially application-independent format.

19. The application of claim 10, in which the application is adapted to store the data in an application-independent format.

20. A data processing system for managing a professional services practice, in machine readable format, comprising:
a. one or more distributed applications;
b. data storage means, cooperating with said one or more distributed applications, for storing the data in a format other than an application-independent format; and
c. case management database means, cooperating with one or more of said data storage means and said one or more distributed applications;
d. said case management database means being adapted to store said data in a substantially portable format;
e. said case management database means being adapted to make the data available to users in the professional services practice.

21. The data processing system of claim 20, wherein said one or more distributed applications are substantially proprietary.

22. The data processing system of claim 20, wherein said one or more distributed applications are proprietary.

23. The data processing system of claim 20, wherein said data storage means being adapted to store the data in a substantially proprietary format.

24. The data processing system of claim 20, wherein said data storage means is adapted to store the data in a proprietary format.

25. The data processing system of claim 20, wherein said data storage means is adapted to store the data in portable format.

26. The data processing system of claim 20, wherein said case management database means further comprises ODBC-compliant database means.

27. The data processing system of claim 20, wherein said case management database means further comprises a Lotus Notes database.

28. The data processing system of claim 20, wherein said case management means is adapted to store the data in a substantially portable format.

29. The data processing system of claim 20, in which said case management means is adapted to store the data in substantially application-independent format.

30. A data processing system for managing data relating to a professional services project, in machine readable format, comprising:
a. the data being in a format other than application-independent format;
b. one or more distributed applications; adapted to access the data;
c. data storage means, cooperating with said one or more distributed applications, for storing the data in a format other than an application-independent format;
d. server means, cooperating with one or more of said one or more of said data storage means and said one or more distributed applications, said server means being adapted to transfer the data; and
e. case management database means, cooperating with one or more of said server means, said data storage means, and said one or more distributed applications, said case management means being adapted for communicating with respect to the data;
f. said case management database means being adapted to store said data in a substantially portable format.

31. The data processing system of claim 30, wherein case management database is adapted to provide the data in substantially portable format to a user.

32. The data processing system of claim 30, wherein said case management database means is adapted to provide the data to one or more of said one or more distributed applications.

33. The data processing means of claim 30, wherein said one or more distributed applications comprise a first application, the data processing system further comprising one or more second applications, and said case management database means is adapted to provide data to one or more of said second applications.

34. The data processing system of claim 30, wherein said one or more distributed applications are proprietary.

35. The data processing system of claim 30, wherein said data storage means is adapted to store the data in a substantially proprietary format.

36. The data processing system of claim 30, wherein said data storage means is adapted to store the data in a proprietary format.

37. The data processing system of claim 30, wherein said data storage means is adapted to store the data in portable format.

38. The data processing system of claim 30, wherein said server means comprises an SQL server.

39. The data processing system of claim 30, wherein said case management database means further comprises ODBC-compliant database means.

40. The data processing system of claim 30, wherein said case management database means further comprises a Lotus Notes database.

41. The data processing system of claim 30, in which said case management means is adapted to store the data in a substantially portable format.

42. The data processing system of claim 30, wherein said case management database means is adapted to store the data in portable format.

43. The data processing system of claim 30, in which said case management means is adapted to store the data in substantially application-independent format.

44. The data processing system of claim 30, wherein said case management database means is adapted to store the data in application-independent format.

45. A user interface for a computer network comprising one or more distributed applications and data storage means used in a professional services practice, comprising:
a. client means in machine readable format for aggregating data relating to the client for whom the professional services are being undertaken;
b. matter means in machine readable format for aggregating data relating to the subject matter of the professional services; and
c. project management means in machine readable format for aggregating data relating to the representation, the data aggregated in the project management means further comprising one or more types of data selected from the group consisting of: conflicts; accounting; docketing; word processing; document management; forms and prior work product precedents; workflow; events; tasks; risk management tools; project management tools;
d. whereby the data is made available to the user.

46. The user interface of claim 45, wherein the data is aggregated without human intervention.

47. The user interface of claim 45, wherein the data is aggregated from the one or more distributed applications.

48. The user interface of claim 45, wherein the data is aggregated from the data storage means.

49. The user interface of claim 45, wherein the data is aggregated from the data storage means cooperating with one or more distributed applications.

50. The user interface of claim 45, wherein the data is aggregated from one or more of the data storage means and the one of more distributed applications.

51. The user interface of claim 45, further comprising event means.

52. The user interface of claim 45, further comprising task means.

53. The user interface of claim 45 further comprising event means and task means.

54. A method for aggregating project management information used in conjunction with a professional services practice, comprising:
a. retaining client-related data associated with the client for whom the project is being undertaken in a first format;
b. retaining project-related data relating to said client in a second format;
c. retaining event-related data relating to the occurrence of one or more events associated with said matter in a third format;
d. aggregating said client-, project-, and event-related data in machine readable format; and
e. making said client-, project-, and event-related data available to the user in a common format.

55. A method of claim 54, further comprising:
a. identifying a client associated with the data;
b. identifying a matter associated with said client;
c. identifying a project being undertaken on behalf of said client in conjunction with said matter;
d. identifying docketing information associated with the project;
e. identifying budget information associated with the project;
f. identifying expense information associated with the project;
g. identifying an event relating to said project;
h. storing said expense information and said docket information in one or more first proprietary formats;
i. transferring said client, matter, budget, expense and docket information to a second common data format;
j. providing said client, matter, expense, and docket information to a user.

56. The method of claim 54, further comprising email notification of recordation of new data.

57. The method of claim 55, further comprising email notification of new data.

58. The method of claim 54, further comprising email notification of events.

59. The method of claim 55, further comprising email notification of events.

60. The method of claim 54, further comprising email notification of tasks.

61. The method of claim 55, further comprising email notification of tasks.

62. The method of claim 54, further comprising email notification of status.

63. The method of claim 55, further comprising email notification of status.

64. The method of claim 54, further comprising tracking exceptions from anticipated flow for a project.

65. The method of claim 55, further comprising tracking exceptions from anticipated flow for a project.

66. A data processing application, in machine readable form, for integrating data relating to a professional services project, comprising:
a. application means, for managing the data, said application means comprising client means for identifying the client, and project means for identifying the project;
b. said client means further comprising data, maintained in a second application, relating to the client for whom the professional services are being performed, the data being selected from the group consisting of: identity of the client, relationships and affiliations of the client to other persons, client number, client contact information, lines of business, products and services, referral information, billing information, and fee-related information; and
c. said project means further comprising data, maintained in a third application, relating to the subject matter of the professional services being performed, the data being selected from the group consisting of: identity of the project, creation date, description, geographic area, jurisdictions, other associate counsel, vendors, responsible attorney, comments, and other pertinent facts relating to the representation;
d. said application means being adapted to maintain the data in substantially portable format.

67. The application of claim 66, wherein said second and third applications comprise a second application.

68. The application of claim 66, further comprising matter means for identifying the matter under which the professional services are being performed.

69. The application of claim 68, wherein said matter means further comprises data selected from the group consisting of: matter name, matter description, matter number, creation date, related matters, billing attorney, responsible attorney, and particulars relating to the subject matter of the representation.

70. The application of claim 66, further comprising event means for identifying events that occur in conjunction with the professional services being rendered.

71. The application of claim 70, wherein said event means further comprises data selected from the group consisting of: event date, event description, milestones, significant of the event to the representation, other events or milestones anticipated based upon the event, the dates of any anticipated events or milestones, copies of pertinent documentation, and other information pertinent to the event.

72. The application of claim 66, further comprising task means for identifying tasks that are to be performed in conjunction with rendering the professionals services.

73. The application of claim 72, wherein said task means further comprises data selected from the group consisting of: the task, any subtasks, the resources required to complete the task, the time required to complete the task, deadlines, priority, status, to whom the task is assigned, who is managing the task, reminders and any other pertinent data relating to the task.

74. The application of claim 66, further comprising one or more of the means selected from the group consisting of: document, forms, workflow, conflicts, accounting, time and billing, expense, budgeting, and reporting means.

75. The application of claim 66, wherein the application is adapted to maintain the data in substantially portable format.

76. The application of claim 66, wherein the application is adapted to maintain the data in portable format.

77. The application of claim 66, wherein the application is adapted to maintain the data in substantially application-independent format.

78. The application of claim 66, wherein the application is adapted to maintain the data ion application-independent format.

79. The application of claim 66, wherein the application is adapted to provide the data to further application means.

80. The application of claim 66, wherein the application is adapted to provide the data to one or more of second and third applications.

81. The application of claim 66, wherein the application is adapted to provide the data to a user.

82. The application of claim 66, wherein the application is adapted to provide the data in substantially portable format to a user.

83. The application of claim 66, comprising ODBC-compliant database means.

84. The application of claim 66, comprising a shareware database.

85. The application of claim 66, comprising a Lotus Notes database.

86. The application of claim 66, in which the application is adapted to store the data in a substantially portable format.

87. The application of claim 66 in which the application is adapted to store the data in a portable format.

88. The application of claim 66, in which the application is adapted to store the data in a substantially application-independent format.

89. The application of claim 66, in which the application is adapted to store the data in an application-independent format.

90. The application of claim 66, wherein the application is adapted for use in a network environment.

91. The application of claim 66, wherein the application is adapted to use in a distributed network environment.

92. A software application, in machine readable form, for integrating data relating to a professional services project, comprising:
a. ODBC-compliant case management database means for managing the data,
b. said case management database means being adapted to cooperate with SQL server means;
c. said case management database application means further comprising client means for identifying the professional services client, and project means for identifying the professional service project;
d. said client means further comprising data, maintained in a second application, relating to the client for whom the professional services are being performed, the data being selected from the group consisting of: identity of the client, relationships and affiliations of the client to other persons, client number, client contact information, lines of business, products and services, referral information, billing information, and fee-related information; and
e. said project means further comprising data, maintained in a third application, relating to the subject matter of the professional services being performed, the data being selected from the group consisting of: identity of the project, creation date, description, geographic area, jurisdictions, other associate counsel, vendors, responsible attorney, comments, and other pertinent facts relating to the representation;
f. said SQL server means being adapted to cooperate with said second and third applications and to communicate the data to said case management database means.
g. said case management database application means being adapted to maintain the data in substantially portable format.

93. The application of claim 92, wherein said second and third applications comprise second application.

94. The application of claim 92, wherein said second and third applications comprise third application.

95. The application of claim 92, further comprising matter means for identifying the matter under which the professional services are being performed.

96. The application of claim 95, wherein said matter means further comprises data selected from the group consisting of: matter name, matter description, matter number, creation date, related matters, billing attorney, responsible attorney, and particulars relating to the subject matter of the representation.

97. The application of claim 92, further comprising event means for identifying events that occur in conjunction with the professional services being rendered.

98. The application of claim 97, wherein said event means further comprises data selected from the group consisting of: event date, event description, milestones, significant of the event to the representation, other events or milestones anticipated based upon the event, the dates of any anticipated events or milestones, copies of pertinent documentation, and other information pertinent to the event.

99. The application of claim 92, further comprising task means for identifying tasks that are to be performed in conjunction with rendering the professionals services.

100. The application of claim 99, wherein said task means further comprises data selected from the group consisting of: the task, any subtasks, the resources required to complete the task, the time required to complete the task, deadlines, priority, status, to whom the task is assigned, who is managing the task, reminders and any other pertinent data relating to the task.

101. The application of claim 92, further comprising one or more of the means selected from the group consisting of: document, forms, workflow, conflicts, accounting, time and billing, expense, budgeting, and reporting means.

102. The application of claim 92, wherein the application is adapted to maintain the data in substantially portable format.

103. The application of claim 92, wherein the application is adapted to maintain the data in portable format.

104. The application of claim 92, wherein the application is adapted to maintain the data in substantially application-independent format.

105. The application of claim 92, wherein the application is adapted to maintain the data in application-independent format.

106. The application of claim 92, wherein the application is adapted to provide the data to further application means.

107. The application of claim 92, wherein the application is adapted to provide the data to one or more of second and third applications.

108. The application of claim 92, wherein the application is adapted to provide the data to a user.

109. The application of claim 92, wherein the application is adapted to provide the data in substantially portable format to a user.

110. The application of claim 92, comprising ODBC-compliant database means.

111. The application of claim 92, comprising a shareware database.

112. The application of claim 92, comprising a Lotus Notes database.

113. The application of claim 92, in which the application is adapted to store the data in a substantially portable format.

114. The application of claim 92 in which the application is adapted to store the data in a portable format.

115. The application of claim 92, in which the application is adapted to store the data in a substantially application-independent format.

116. The application of claim 92, in which the application is adapted to store the data in an application-independent format.

117. The application of claim 92, wherein the application is adapted for use in a network environment

118. The application of claim 92, wherein the application is adapted to use in a distributed network environment.
